(19) United States
(12) Patent Application Publication
(10) Pub. No.: US 2006/0294089 A1
(43) Pub. Date: Dec. 28, 2006

(54) Filter manager system and method of managing filter expressions

(76) Inventors: Jerome Devost, Ottawa (CA); Colin Phillips, Ottawa (CA); Ilse Breedvelt-Schouten, Manotick (CA)

Correspondence Address: PEARNE & GORDON LLP, 1801 EAST 9TH STREET, SUITE 1200, CLEVELAND, OH, 44114-3108, US

(21) Appl. No.: 11/195,271

(22) Filed: Aug. 2, 2005

(30) Foreign Application Priority Data
Jun. 23, 2005 (CA) 2,510,661

(51) Int. Cl. G06F 17/30

(52) U.S. Cl. 707/4

(57) ABSTRACT

A filter manager system has a predicate combiner for handling grouping of predicates with brackets into one or more predicate groups based on a user input. The system also has an operator handler for handling one or more operators between the predicate groups to compose a filter. A filter user interface of the system receives the user input and presents the predicates and the operators to the user based on information from the predicate combiner and the operator handler.

### FIELD OF INVENTION

The present invention relates to a filter manager system and method of managing filter expressions.

### BACKGROUND OF THE INVENTION

In the business intelligence reporting and analysis domain, users often need to be able to create multiple filter criteria, and use operators AND/OR and brackets to group filter predicates together. A “predicate” is a simple statement in a filter expression, e.g., Sales>10,000.

In the business world, many business users want to create filter expressions when viewing their business data. Simple filter expressions are often easy to create for them. An example of a simple filter expression is: Sales from 10,000 to 200,000. In some business intelligence reporting and analysis tools, multiple simple filter expressions may be put together with an implicit AND between the predicates. However, if the user wants to create filter criteria that fit their business need, they need to create more complex filter expressions. For example: (Sales<10,000 AND ProductLine=Bicycle) OR (Sales>100,000 AND Cost<50,000)

Most existing user interfaces only offer an expression editor to provide the more complex filter expression. Expression editors involve much more knowledge and skill in creating complex filter expressions. An expression editor has a list of functions and operators, from which the user can choose desired functions and operators. Filter expressions created in expression editors are often error prone. It is typically difficult for business users to create a good filter expression.

An expression editor has a list of functions and operators, from which the user can choose freely. Using expression editors, the filter expressions are presented to the user the same way they are used by the system. These expressions can look very complex to some users.

Sometimes there are simple filter expression creators where the user can list single predicates into a set of predicates, but they only support an AND/OR switch between the predicates. These filter expression creators do not provide bracketing, and do not allow the users to group elements together.

It is therefore desirable to provide a mechanism that allows a user to create complex filter expressions without the need to enter an expression editor which involves more knowledge and skill.

### SUMMARY OF THE INVENTION

It is an object of the invention to provide an improved filter manager system.

The invention uses a filter predicate combiner that combines predicates with brackets to group filter predicates.

In accordance with an aspect of the present invention, there is provided a filter manager system comprising predicate combiner, an operator handler and a filter user interface. The predicate combiner is provided for handling grouping of predicates with brackets into one or more predicate groups based on a user input. The operator handler is provided for handling one or more operators between the predicate groups to compose a filter. The filter user interface is provided for receiving the user input and for presenting the predicates and the operators to the user based on information from the predicate combiner and the operator handler.

In accordance with another aspect of the invention, there is provided a filter manager system comprising a basic filter manager, a combine filter manager, and an operator handler. The basic filter manager is provided for handling one or more basic filter predicates. The basic filter manager provides a simple filter user interface for a user to manipulate the basic filter predicates. The combine filter manager is provided for handling grouping of one or more basic filter predicates to define one or more combined filters. The combine filter manager provides a combine filter user interface for the user to define the combined filters. The operator handler is provided for handling one or more operators between the combined filter to generate a filter expression for the combined filter.

In accordance with another aspect of the invention, there is provided a combine filter user interface comprising a dialog, a combine filter control, and an operator selector. The dialog is provided for presenting a list of predicates for allowing a user to select one or more predicates or predicate groups. The combine filter control is provided for combining the selected predicates as a predicate group, and presenting the predicate group with a set of brackets. The operator selector is provided for allowing the user to select an operator between predicates or predicate groups.

In accordance with another aspect of the invention, there is provided a method of managing a filter expression. The method comprises the steps of presenting a user predicates for selection; receiving a user input of selected predicates; grouping the selected predicates with brackets into one or more predicate groups; providing one or more operators between the predicate groups to define a composed filter; and presenting the user the composed filter with the brackets and the operators.

In accordance with another aspect of the invention, there is provided a computer readable medium storing computer readable code for use in the execution in a computer of the method of managing a filter expression. The method comprises the steps of presenting a user predicates for selection; receiving a user input of selected predicates; grouping the selected predicates with brackets into one or more predicate groups; providing one or more operators between the predicate groups to define a composed filter; and presenting the user the composed filter with the brackets and the operators.

In accordance with another aspect of the invention, there is provided a propagated signal carrier containing computer executable instructions and/or statements that can be read and executed by a computer. The computer executable instructions are used to execute the method of managing a filter expression.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a filter manager system in accordance with an embodiment of the present invention;

FIG. 2 is a block diagram showing the detail of the filter manager system;

FIG. 3 is a flowchart showing the operation of the filter manager system;

FIG. 4 is a diagram showing an example of a user interface presentation of the filter manager system;

FIG. 5 is a diagram showing an example of a AND/OR switch control;

FIG. 6 is a diagram showing another example of a user interface presentation of the filter manager system;

FIG. 7 is a diagram showing another example of a user interface presentation of the filter manager system;

FIG. 8 is a diagram showing another example of a user interface presentation of the filter manager system;

FIG. 9 is a diagram showing another example of a user interface presentation of the filter manager system;

FIG. 10 is a diagram showing another example of a user interface presentation of the filter manager system;

FIG. 11 is a diagram showing another example of a user interface presentation of the filter manager system;

FIG. 12 is a diagram showing updating of the filters;

FIG. 13 is a block diagram showing a filter manager system in accordance with another embodiment of the present invention;

FIG. 14 is a block diagram showing the detail of the filter manager system; and

FIG. 15 is a flowchart showing the operation of the filter manager system.

### DETAILED DESCRIPTION

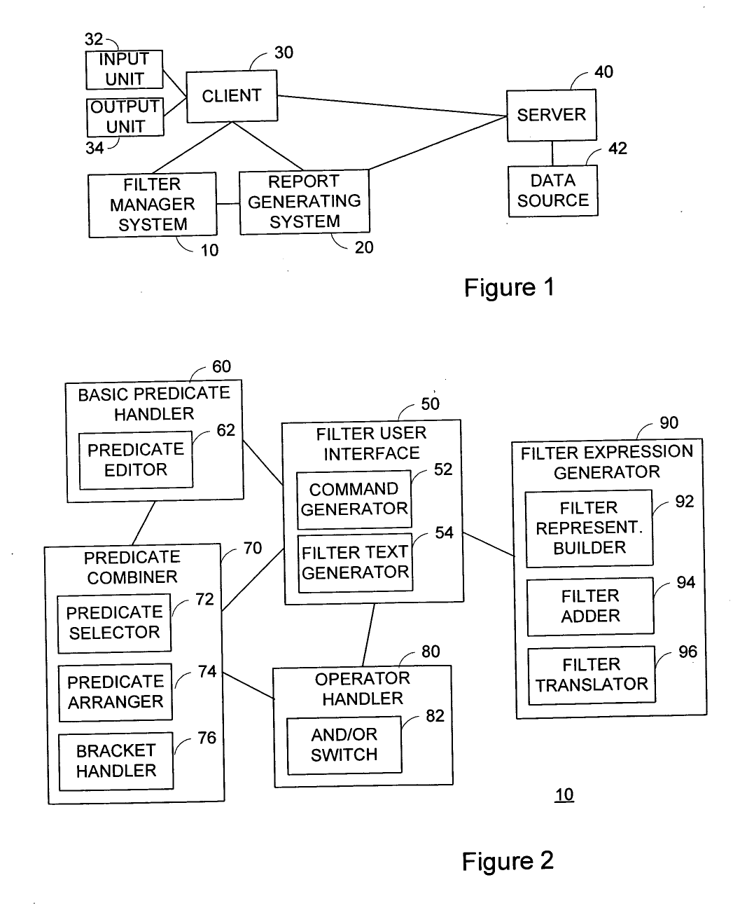

FIG. 1 shows a filter manager system 10 in accordance with an embodiment of the present invention. The filter manager system 10 is used with or within a report generating system 20. Users use client 30 to request reports to one or more servers 40. The servers 40 execute the requests using one or more associated data sources 42. The client 30 has an input unit 32 and output unit 34.

The filter manager system 10 provides an in-between mechanism that helps business users to create complex filter expressions without the need to know details of a filter expression editor.

The filter manager system 10 has a filter user interface 50, a basic predicate handler 60, a predicate combiner 70 and an operator handler 80.

The basic predicate handler 60 handles individual filter predicates. The basic predicate handler 60 has a predicate editor 62 that allows the user to manipulate filter predicates, e.g., create and modify each filter predicate. The predicate editor 62 may provide a simple user interface for this purpose. The simple user interface may present a “From-To” selection, and/or various functions and operators, such as > and <.

The predicate combiner 70 allows the user to combine filter predicates. The predicate combiner 70 has a predicate selector 72, a predicate arranger 74 and a bracket handler 76. The predicate selector 72 allows the user to select multiple predicates to group them. Also, the predicate selector 72 allows the user to select one or more predicate groups to ungroup them. The predicate arranger 74 arranges the order of the predicates based on the grouped predicates. The bracket handler 76 provides brackets to the grouped predicates, or remove brackets from predicate groups that are ungrouped. The bracket handler 76 allows nested groups, and provides brackets according to the nested groups.

The operator handler 80 handles operators for the grouped predicates. The operator handler 80 has an AND/OR switch 82 that allows the user to switch between operators AND and OR.

The filter user interface 50 presents filter predicates and operators based on information from the basic predicate handler 60, the predicate combiner 70, and the operator handler 80. The filter user interface 50 has a command generator 52 that generates a command that describes the filter as presented by the filter user interface 50. The filter user interface 50 also has a filter text generator 54 that takes a filter representation and generates a text for the filter that is human readable or user friendly, instead of a mathematical expression.

The filter manager system 10 may also have a filter expression generator 90 that generates a filter expression based on the command describing the composed filter. The filter expression generator 90 may have a filter representation builder 92, a filter representation adder 94, and a filter translator. The filter representation builder 92 builds, using the command describing the filter, a representation of the filter that the server 40 understands, such as an XML representation of the filter. The filter representation adder 94 adds the filter representation to a query of the report generating system 20 that corresponds to a report specification used by the server 40. The filter translator 96 generates a filter expression understood by the server 40.

The filter expression generator 90 may be part of the report generating system 20 in a different embodiment.

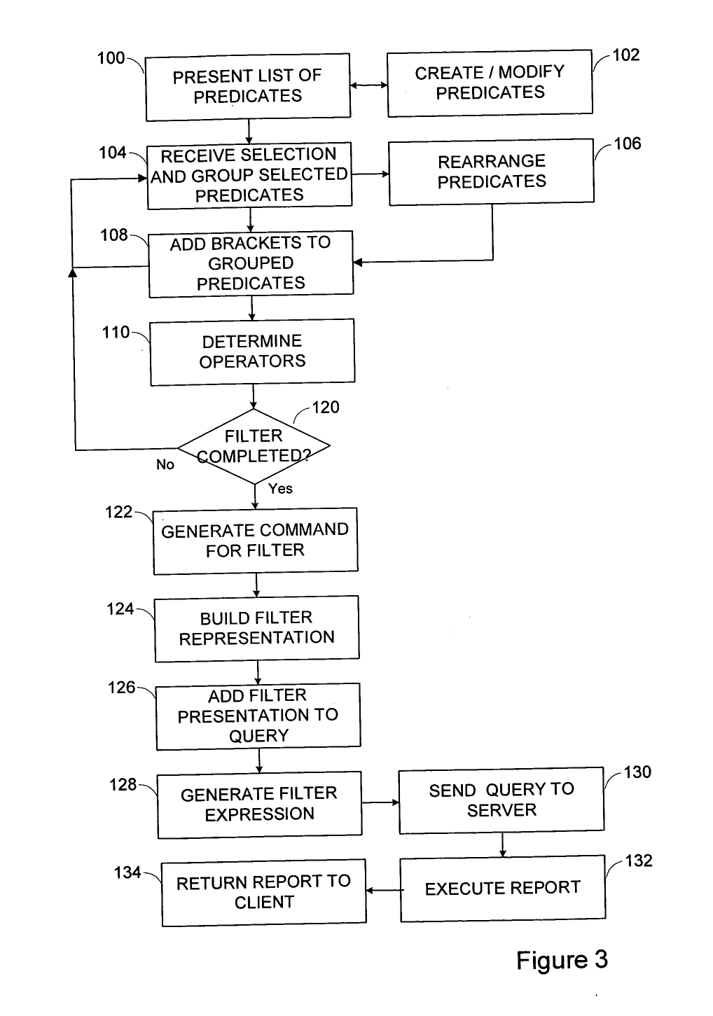

The operation of the filter manager system 10 is now described referring to FIG. 3.

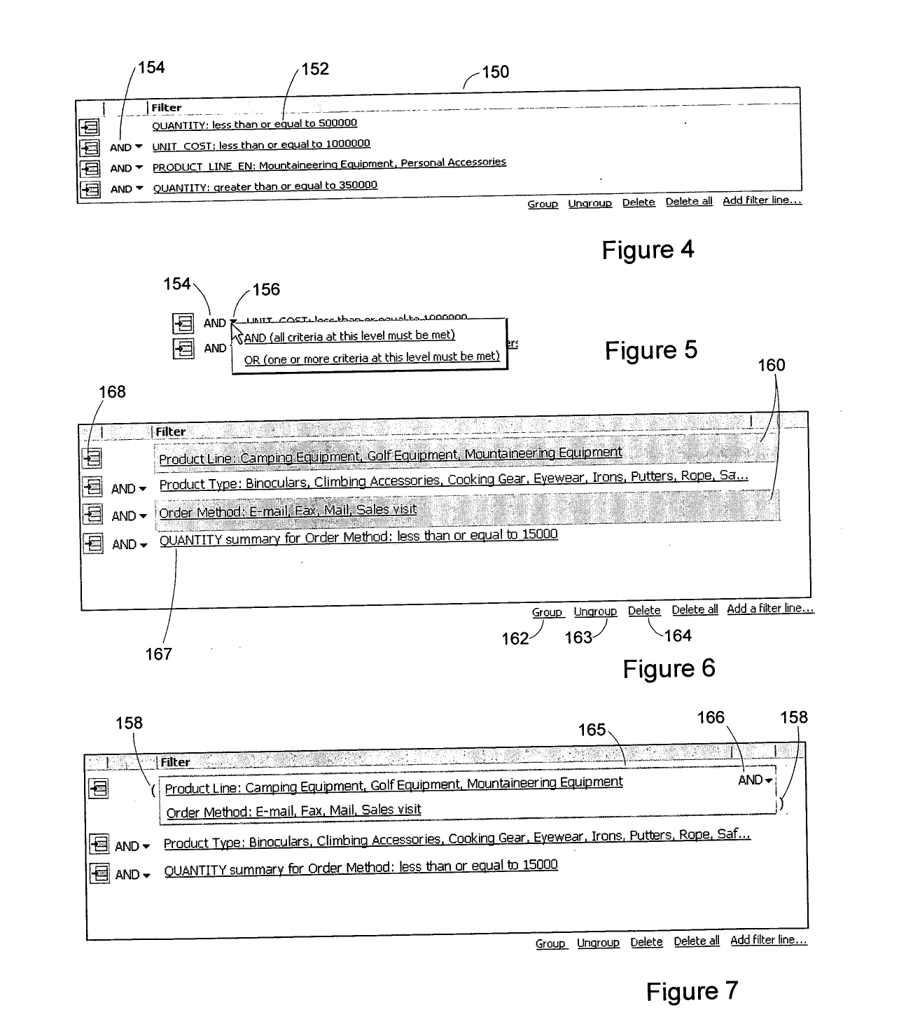

A user at client 30 is requesting the generation of a report using the report generating system 20. When the user selects to include a filter, the filter user interface 50 presents a filter combine dialog. In the dialog, the basic predicate handler 60 presents a list of existing filter predicates (100). An example of such a list is shown in FIG. 4. In this example, a filter combine dialog 150 lists four filter predicates 152. This embodiment presents the list of filter predicates 152 such that the filter predicates 152 are automatically combined with AND 154. The user may change AND to OR, or vice versa, by using an operator selection control 156 provided beside the AND 154, as shown in FIG. 5. In a different embodiment, filter predicates may be initially combined with OR, or they may be presented as a simple list for the user to select the combine operator as desired.

In order to present a list of filter predicates, the filter user interface 50 invokes the filter text generator 54 to convert the filter representation of each predicate and generate a human-readable text for the predicate. Thus, the filter user interface 50 can present a human-readable text for the predicates or filter to the user, instead of a mathematical expression for the predicates.

If there are no existing filter predicates, the predicate editor 62 provides a predicate editing dialog that allows the user to create filter predicates (102). The created filter predicates are added to the list that is presented to the user in the filter combine dialog. Similarly, when the user wants to modify existing or created predicates, the predicate editor 62 allows the user to modify a selected predicate through the predicate editing dialog.

From the list of the filter predicates, the predicate selector 72 of the predicate combiner 70 allows the user to select predicates that the user wants to group (104). When the user selects and groups the predicates that are not ordered one after the other, the predicate arranger 74 rearranges the order of the predicates, as necessary, such that the grouped predicates are ordered together (106). The bracket handler 76 automatically adds brackets to the grouped predicates together (108).

FIG. 6 shows an example where the user selected the first and third predicates, which are highlighted 160. When the user selects them to group through a group control 162, as shown in FIG. 7, the third predicate is moved up (rearranged) together with the first predicate, and boxes 165 and brackets 158 are added to group the first predicate and the moved predicate which is now on the second line. Also, the operator “AND” 166 is moved in that group as well.

The user may group other predicates as desired by repeating selection and grouping of desired predicates (104). The AND/OR switch 82 allows the user to switch operators combining the grouped predicates from AND to OR, or vice versa (110).

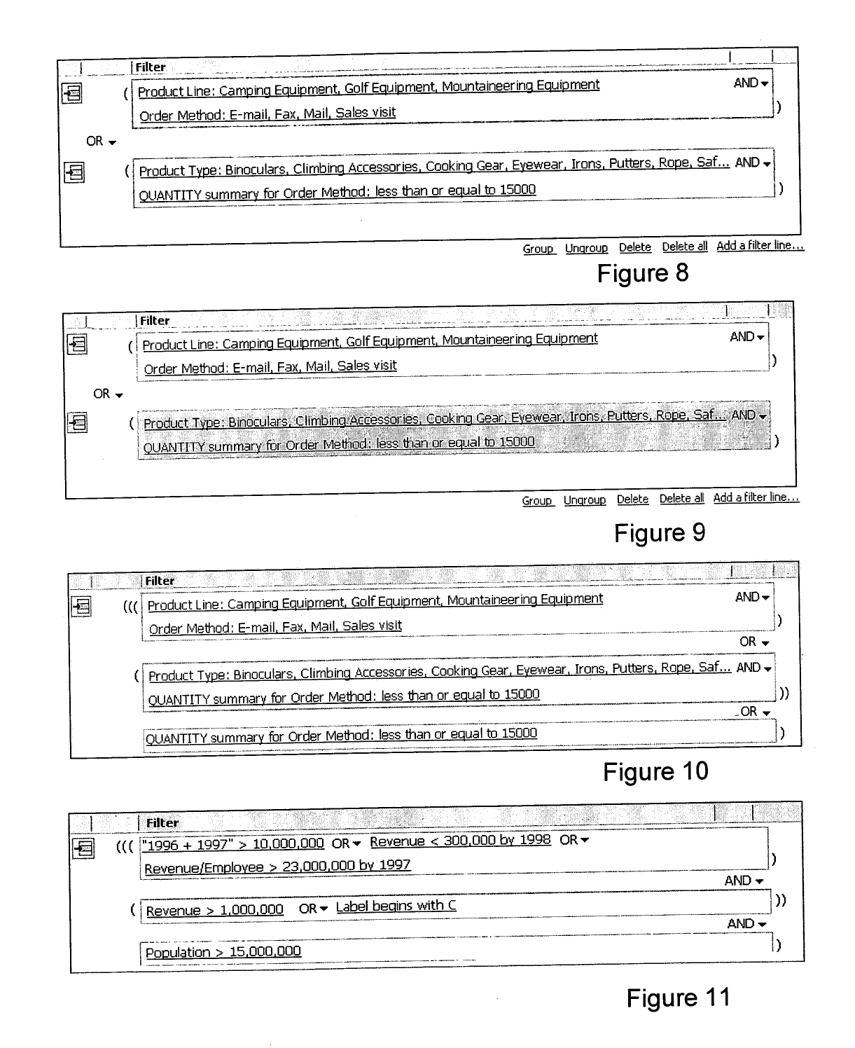

FIG. 8 shows that the user grouped the remaining predicates on the third and fourth lines, and also changed the operator between the first group of predicates and the second group of predicates from AND to OR.

The filter user interface 50 also allows the user to select a group of predicates, as shown in FIG. 9, and ungroup, modify or delete the group.

As shown in FIG. 6, the filter user interface 50 provides a group control 162, ungroup control 163, and delete control 164 so that the user may select one or more predicates or predicate groups, and group them, ungroup them, or delete them through these controls.

The filter user interface 50 may provide a hyperlink 167 and/or selection icon 168 to each predicate in the filter combine dialog, as shown in FIGS. 4-9. The selection icon 168 allows the user to select a line of a single predicate or a line of a bracketed group of predicates in order to group, ungroup or delete the selected line. The invocation of the hyperlink 167 brings the user to the predicate editing dialog for modification of the predicate through the predicate editor 60. An alternative to a hyperlink 167 may be a double click on the predicate.

Referring back to FIG. 3, once the user finishes the composition of a desired filter (120) through the filter composition dialog 150, the filter user interface 50 generates using the command generator 52 a command that describes the composed filter (122). The command describes the composed filter using multiple filter elements.

The filter expression generator 90 receives the command, and based on the filter elements in the command, builds a representation of the filter that the server 40 understands (124). The filter expression generator 90 adds the filter representation to a query of the report generating system 20 (126), and translates the filter representation into a full filter expression understood by the server 40 (128).

After the specification of the report is fully generated with the filter expression, the report generating system 20 sends the request to the server 40 to render the report (130). The server 40 executes the report using the full filter expression (132), and returns the report to the client 30 (134). The filter representation may be part of the response. In that case, the filter representation is converted into an object that the client 30 presents to the user.

The command generation 122 to the generation of the filter expression 128 are further described using an example where a user composes a filter which has two predicates combined by AND. The filter user interface 50 generates a command, e.g.,

AND,2,[Quantity]in_range{:10},[Cost]in_range{:20}.

The command includes multiple items. The first item in the command is how the predicates are grouped together, i.e., in this case, using AND operator. The second item is the number of predicates following in the list for this group. The next two items are predicates, either a filter expression understood by the server or an other group. This command is a filter tree traversed in a preorder (prefix) fashion.

The filter user interface 50 sends the command to the report generating system 20. The report generating system 20 keeps a query corresponding to a report specification used by the server 40. This query also contains extra information on the context of each filter item in the command. The context information is used by the client 30 to identify on which items commands are executed. To this end, the client 30 may use id, type and summary attributes in an XML representation of the filter as context. This context is used when editing an existing predicate. It provides information on the type of dialog to use for editing. The context information is also used to help the client to deal with different types of items, such as data types like measures, dates, numbers, text, intervals, and identifiers.

The command is processed to build a representation of the filter which is added to the query of the report generating system 20. In this example, The command is processed to build an XML representation of the filter. The command is added to the query:

<FilterGroup operator=“AND”>

<Filter columnId=“Quantity” id=“F1” type=“measure” summary=“true”

use=“optional”>

<FilterExpression>[Quantity] in_range {:10}</FilterExpression>

</Filter>
<Filter columnId=“Cost” id=“F2” type=“measure” summary=“true”

use=“optional”>

<FilterExpression>[Cost] in_range {:20}</FilterExpression>

</Filter>

</FilterGroup>

The attributes for the filter nodes in this query are derived from the current context of the query of the report generating system 20.

The XML representation of the filter is now translated into a full filter expression understood by the server 40:
[Quantity] in_range {:10} and [cost] in_range {:20}

When the executed report is returned to the client 30 at step 130, the XML representation of the filters is also part of the response. The XML code is then processed to construct corresponding JavaScript objects (FilterGroup and Filter objects). These JavaScript object are used to render human-readable texts used in the user interface. Therefore, the users can see the description of the filter in a natural way, and do not need to understand complex syntax used by the server 40.

Examples of XML representations of filters as modified as shown in FIGS. 4, 6 and 8 are now described.

Before filters are grouped, as shown in FIG. 6, the XML representation is:

<FilterGroup operator=“AND”>

<Filter columnId=“Product line” id=“F1” type=“picklist” summary=“true”

use=“optional”>

<FilterExpression>[Product line] in (‘Camping Equipment’, ‘Golf

Equipment’, ‘Mountaineering Equipment’)</FilterExpressin>

</Filter>
<Filter columnId=“Product type” id=“F2” type=“picklist” summary=“true”

use=“optional”>

<FilterExpression>[Product type] in (‘Binoculars’,‘Climbing

Accessories’, ‘Cooking Gear’, ‘Eyewear’, ‘Irons’, ‘Putters’, ‘Rope’, ‘Safety
Equipment’)</FilterExpression>

</Filter>
<Filter columnId=“Order method” id=“F3” type=“picklist” summary=“true”

use=“optional”>

<FilterExpression>[Order method] in (‘E-mail’,‘Fax’,‘Mail’,‘Sales

visit’)</FilterExpresion>

</Filter>
<Filter columnId=“Quantity” id=“F4” type=“measure” summary=“Order

Method” use=“optional”>

<FilterExpression>[Quantity] in_range {:15000}</FilterExpression>

</Filter>

</FilterGroup>

Filter expression in the report specification is as follows:

[Product line] in (‘Camping Equipment’, ‘Golf Equipment’, ‘Mountaineering Equipment’) and [Product type] in (‘Binoculars’, ‘Climbing Accessories’, ‘Cooking Gear’, ‘Eyewear’, ‘Irons’, ‘Putters’, ‘Rope’, ‘Safety Equipment’) and [Order method] in (‘E-mail’, ‘Fax’, ‘Mail’, ‘Sales visit’) and [Quantity] for [Order Method] in_range {:15000}

After filters are grouped, as shown in FIG. 7, the XML representation is:

<FilterGroup operator=“AND”>

<FilterGroup operator=“AND”>

<Filter columnId=“Product line” id=“F1” type=“picklist”

summary=“true” use=“optional”>
<FilterExpression>[Product line] in (‘Camping Equipment’, ‘Golf Equipment’,
‘Mountaineering Equipment’)</FilterExpression>

</Filter>
<Filter columnId=“Order method” id=“F3” type=“picklist”

summary=“true” use=“optional”>

<FilterExpression>[Order method] in (‘E-

mail’,‘Fax’,‘Mail’,‘Sales visit’)</FilterExpression>

</Filter>

</FilterGroup>
<Filter columnId=“Product type” id=“F2” type=“picklist” summary=“true”

use=“optional”>

<FilterExpression>[Product type] in (‘Binoculars’,‘Climbing

Accessories’, ‘Cooking Gear’, ‘Eyewear’, ‘Irons’, ‘Putters’, ‘Rope’, ‘Safety
Equipment’)</FilterExpression>

</Filter>
<Filter columnId=“Quantity” id=“F4” type=“measure” summary=“Order

Method” use=“optional”>

<FilterExpression>[Quantity] in_range {:15000}</FilterExpression>

</Filter>

</FilterGroup>

Filter expression in the report specification is:

([Product line] in (‘Camping Equipment’, ‘Golf Equipment’, ‘Mountaineering Equipment’) and [Order method] in (‘E-mail’, ‘Fax’, ‘Mail’, ‘Sales visit’)) and [Product type] in (‘Binoculars’, ‘Climbing Accessories’, ‘Cooking Gear’, ‘Eyewear’, ‘Irons’, ‘Putters’, ‘Rope’, ‘Safety Equipment’) and [Quantity] for [Order Method] in_range {:15000}

When the remaining predicates are grouped and the AND between the groups is changed to an OR operator, as shown in FIG. 8, the XML representation is:

<FilterGroup operator=“OR”>

<FilterGroup operator=“AND”>

<Filter columnId=“Product line” id=“F1” type=“picklist”

summary=“true” use=“optional”>

<FilterExpression>[Product line] in (‘Camping Equipment’,

‘Golf Equipment’, ‘Mountaineering Equipment’)</FilterExpression>

</Filter>
<Filter columnId=“Order method” id=“F3” type=“picklist”

summary=“true” use=“optional”>

<FilterExpression>[Order method] in (‘E-

mail’,‘Fax’,‘Mail’,‘Sales visit’)</FiIterExpression>

</Filter>

</FilterGroup>
<FilterGroup operator=“AND”>

<Filter columnId=“Product type” id=“F2” type=“picklist”

summary=“true” use=“optional”>

<FilterExpression>[Product type] in (‘Binoculars’,‘Climbing

Accessories’, ‘Cooking Gear’, ‘Eyewear’, ‘Irons’, ‘Putters’, ‘Rope’, ‘Safety
Equipment‘)</FilterExpression>

</Filter>
<Filter columnId=“Quantity” 1d=“F4” type=“measure⇄

summary=“Order Method” use=“optional”>

<FilterExpression>[Quantity] in_range

{:15000}</FilterExpression>

</Filter>

</FilterGroup>

</FilterGroup>

Filter expression in the report specification is:

([Product line] in (‘Camping Equipment’, ‘Golf Equipment’, ‘Mountaineering Equipment’) and [Order method] in (‘E-mail’, ‘Fax’, ‘Mail’, ‘Sales visit’)) or ([Product type] in (‘Binoculars’, ‘Climbing Accessories’, ‘Cooking Gear’, ‘Eyewear’, ‘Irons’, ‘Putters’, ‘Rope’, ‘Safety Equipment’) and [Quantity] for [Order Method] in_range {:15000})

FIG. 10 shows an example of nested groups with multiple brackets automatically added. The XML representation of this example is:

<FilterGroup operator=“OR”>

<FilterGroup operator=“AND”>

<Filter columnId=“Product line” id=“F1” type=“picklist”

summary=“true” use=“optional”>
<FilterExpression>[Product line] in (‘Camping Equipment’, ‘Golf Equipment’,
‘Mountaineering Equipment’)</FilterExpression>

</Filter>
<Filter columnId=“Order method” id=“F3” type=“picklist”

summary=“true” use=“optional” >

<FilterExpression>[Order method] in (‘E-

mail’,‘Fax’,‘Mail’,‘Sales visit’)</FilterExpression>

</Filter>

<FilterGroup>
<FilterGroup operator=“AND”>

<Filter columnId=“Product type” id=“F2” type=“picklist”

summary=“true” use=“optional”>

<FilterExpression>[Product type] in (‘Binoculars’,‘Climbing

Accessories’, ‘Cooking Gear’, ‘Eyewear’, ‘Irons’, ‘Putters’, ‘Rope’, ‘Safety
Equipment’)</FilterExpresion>

</Filter>
<Filter columnId=“Quantity” id=“F4” type=“measure”

summary=“Order Method” use=“optional”>

<FilterExpression>[Quantity] in_range

{:15000}</FilterExpression>

</Filter>

</FilterGroup>
<Filter columnId=“Quantity” id=“F5” type=“measure” summary=“Order

Method” use=“optional”>

<FilterExpression>[Quantity] in_range {:15000}</FilterExpression>

</Filter>

</FilterGroup>

Filter expression in the report specification (FIG. 10) is:

(([Product line] in (‘Camping Equipment’, ‘Golf Equipment’, ‘Mountaineering Equipment’) and [Order method] in (‘E-mail’, ‘Fax’, ‘Mail’, ‘Sales visit’)) or ([Product type] in (‘Binoculars’, ‘Climbing Accessories’, ‘Cooking Gear’, ‘Eyewear’, ‘Irons’, ‘Putters’, ‘Rope’, ‘Safety Equipment’) and [Quantity] for [Order Method] in_range {:15000})) or [Quantity] for [Order Method] in_range {:15000}

FIG. 11 shows another example of nested groups with multiple brackets automatically added.

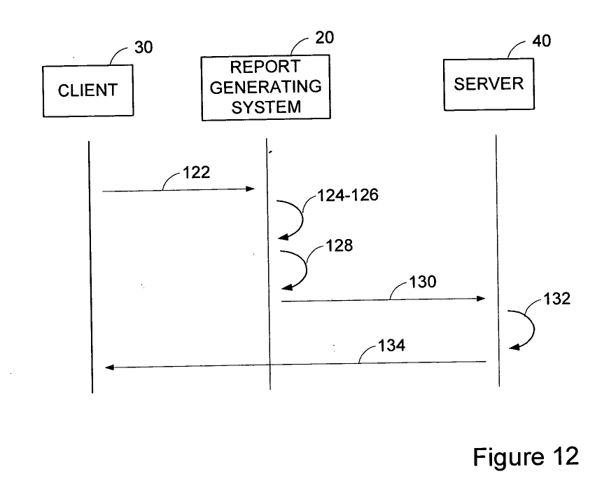

FIG. 12 shows how the system updates filters. The flow of a filter is shown between the client 30, the report generating system 20 and the server 40, referring to the steps shown in FIG. 3.

In the above embodiment, XML is used as a language of the filter representation, but other languages may be used in different embodiments.

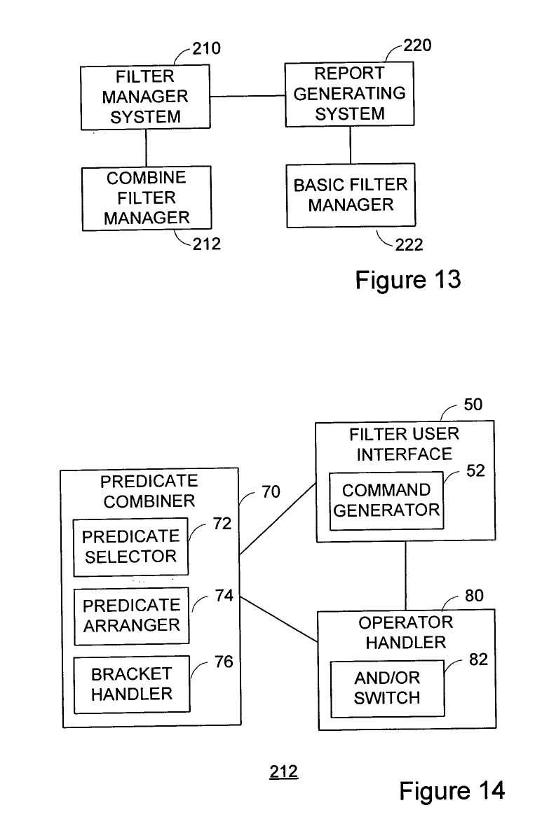

FIG. 13 shows a filter manager system 210 in accordance with another embodiment of the invention. In this embodiment, the filter manager system 210 works with or within a report generating system 220 that has a basic filter manager 222. The basic filter manager 222 provides a simple filter dialog to allow the user to generate and edit basic filters.

The filter manager system 210 provides advanced filter generation through a combine filter manager 212 that manages grouped or combined filters. As shown in FIG. 14, the combine filter manager 212 has a filter user interface 50, predicate combiner 70 and operator handler 80 that are similar to those described in the embodiment shown in FIG. 2, and thus illustrated using the same reference numerals. Through the filter user interface 50, the combine filter manager 212 provides a combine filter dialog, which is similar to those shown in FIGS. 4-11.

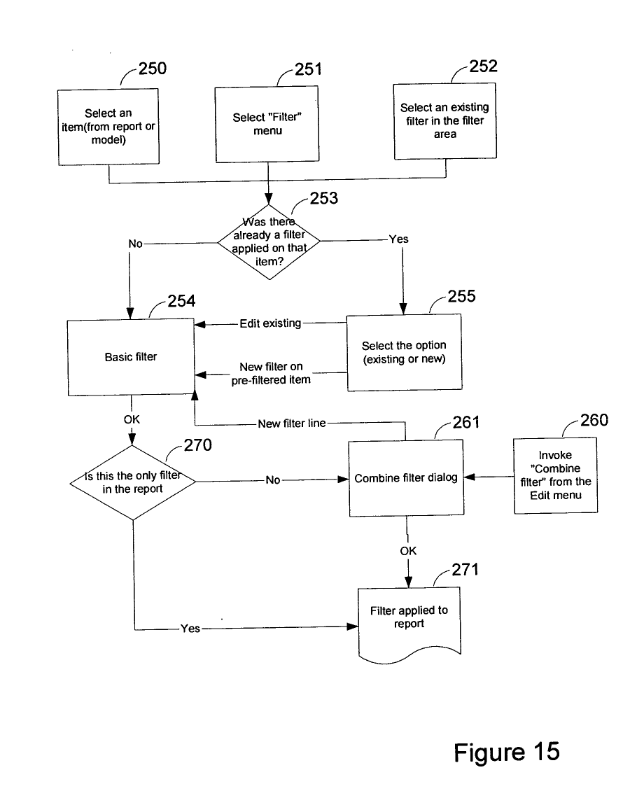

FIG. 15 shows an interaction flow for the basic filters and combine filters. When an item is selected (250), a filter menu is selected (251), or an existing filter is selected (252), the system 210 checks if there was already a filter applied on the selected item (253). If no, the system 210 brings the user to the basic filter manager 222 (254). If there was a filter already applied (253), the system 210 provides the options (255) to edit existing filter, or create a new filter on pre-filtered item, using the basic filter (254). Also, the combine filter manager 212 is invoked (260), and a combine filter dialog is presented (261). To create a new filter line or new predicate, the combine filter manager 212 brings the user to the basic filter manager 222 (254). Once all basic filter or filters are prepared, the system checks if the filter is the only filter in the report (270). If yes, the filter is applied to the report (271). If no, the system 210 brings the user to the combine filter dialog (261) and allows the user to combine the filters or filter predicates. Once the combining of the filters is completed, the combined filter is applied to the report (271).

In this embodiment, the filter manager system 210 can use the “simple filter dialog” existing in the report generating system 220 where the user can create a single simple filter predicate. Accepting a change in the “simple filter dialog” automatically brings the user back to the combine filters dialog where the user can then change the grouping based on the changes to the individual filters or predicates.

The filter manager system 10, 210 provides visual clear indication of what predicates are grouped together. It allows OR/AND changes with direct manipulation by the user and applies the changes to the grouping level in which the groups reside. Thus, the filter manager system allows business users to create more advanced filter expressions, without the need to learn to edit a filter in an advanced expression editor. It also breaks up the implementation of the filter expressions in pieces, which allows easier management and presentation of the filter expressions to the users. For example, filter predicates and filter grouping are independents. This modularity facilitates the handling of the filters and how they are presented to the user. Each predicate is presented in a human-readable string and easily generated because the text for each predicate is created independently from each other. Brackets are automatically included, and users do not need to keep track of how many brackets they need to include.

The filter manager system of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements, which may be embedded in a carrier wave may be transmitted via a communication network. Such a computer readable memory and a computer data signal and/or its carrier are also within the scope of the present invention, as well as the hardware, software and the combination thereof.

While particular embodiments of the present invention have been shown and described, changes and modifications may be made to such embodiments without departing from the scope of the invention. For example, the elements of the filter manager system are described separately, however, two or more elements may be provided as a single element, or one or more elements may be shared with other components in computer systems.

What is claimed is:

1. A filter manager system comprising:
a predicate combiner for handling grouping of predicates with brackets into one or more predicate groups based on a user input;
an operator handler for handling one or more operators between the predicate groups to compose a filter; and
a filter user interface for receiving the user input and for presenting the predicates and the operators to the user based on information from the predicate combiner and the operator handler.

2. The filter manager system as claimed in claim 1, wherein the predicate combiner comprises:
a predicate selector for selecting multiple predicates for determining the predicate groups based on the user input;
a bracket handler for automatically adding a set of brackets to each of the predicate groups.

3. The filter manager system as claimed in claim 2, wherein the predicate combiner further comprises:
a predicate arranger for arranging the predicates such that the grouped predicates are ordered together.

4. The filter manager system as claimed in claim 1, wherein the operator handler has an AND/OR switch for allowing the user to switch operators between AND and OR.

5. The filter manager system as claimed in claim 1 further comprising:
a basic predicate handler for handling creation and modification of the predicates to provide the predicates to the predicate combiner.

6. The filter manager system as claimed in claim 1, wherein the filter user interface has a command generator for generating a command describing the composed filter.

7. The filter manager system as claimed in claim 6 further comprising:
a filter expression generator for generating a filter expression based on the command describing the composed filter.

8. The filter manager system as claimed in claim 7, wherein the filter expression generator comprises:
a filter representation builder for building from the command a filter representation that is understandable by a server that executes a report using the filter expression; and
a filter adder for adding the filter representation to a query that is to be sent to the server.

9. The filter manager system as claimed in claim 8, wherein the filter expression generator further comprises:
a filter translator for translating the filter representation in the query into a filter expression that the server is capable of handling.

10. The filter manager system as claimed in claim 8, wherein the filter user interface has a filter text generator for generating a human readable text of the predicates based on the filter representation.

11. A filter manager system comprising:
a basic filter manager for handling one or more basic filter predicates, the basic filter manager providing a simple filter user interface for a user to manipulate the basic filter predicates;
a combine filter manager for handling grouping of one or more basic filter predicates to define one or more combined filters, the combine filter manager providing a combine filter user interface for the user to define the combined filters; and
an operator handler for handling one or more operators between the combined filter to generate a filter expression for the combined filter.

12. The filter manager system as claimed in claim 11, wherein the combine filter manager has a bracket handler to add a set of brackets to each of the combined filters.

13. A combine filter user interface comprising:
a dialog for presenting a list of predicates for allowing a user to select one or more predicates or predicate groups;
a combine filter control for combining the selected predicates as a predicate group, and presenting the predicate group with a set of brackets; and
an operator selector for allowing the user to select an operator between predicates or predicate groups.

14. The combine filter user interface as claimed in claim 13, wherein the dialog allows the user to delete one or more selected predicates or predicate groups.

15. The combine filter user interface as claimed in claim 13, wherein
the dialog allows the user to select one or more predicate groups for ungrouping; and
the combine filter control performs ungrouping of the selected predicate groups by removing the brackets, and presents predicates of the ungrouped predicate groups individually.

16. A method of managing a filter expression, the method comprising steps of:
presenting a user predicates for selection;
receiving a user input of selected predicates;
grouping the selected predicates with brackets into one or more predicate groups;
providing one or more operators between the predicate groups to define a composed filter; and
presenting the user the composed filter with the brackets and the operators.

17. The method as claimed in claim 16, wherein the grouping step comprises the step of automatically adding a set of brackets to each of the predicate groups.

18. The method as claimed in claim 16, wherein the grouping step having the step of arranging the predicates such that the grouped predicates are ordered together.

19. The method as claimed in claim 16, wherein the operator providing step having the step of allowing the user to switch operators between AND and OR.

20. The method as claimed in claim 16 further comprising the steps of:
providing a predicate manager user interface; and
allowing creation and modification of one or more predicates.

21. The method as claimed in claim 16 further comprising the step of:
generating a command describing the composed filter.

22. The method as claimed in claim 21 further comprising the step of:
generating a filter expression based on the command describing the composed filter.

23. The method as claimed in claim 22, wherein the filter expression generating step comprises the steps of:
building from the command a filter representation that is understandable by a server that executes a report using the filter expression;
adding the filter representation to a query that is to be sent to the server; and
translating the filter representation in the query into a filter expression that the server is capable of handling.

24. The method as claimed in claim 16 further comprising the steps of:
sending the query with the filter expression to a server to execute the query to generate a report; and
returning the report to the user with the filter representation in a user readable format.

25. A computer readable medium storing computer readable code for use in the execution in a computer of a method of managing a filter expression, the method comprising the steps of:
presenting a user predicates for selection;
receiving a user input of selected predicates;
grouping the selected predicates with brackets into one or more predicate groups;
providing one or more operators between the predicate groups to define a composed filter; and
presenting the user the composed filter with the brackets and the operators.

26. A propagated signal carrier containing computer executable instructions and/or statements that can be read and executed by a computer, the computer executable instructions being used to execute a method of managing a filter expression, the method comprising the steps of:
presenting a user predicates for selection;
receiving a user input of selected predicates;
grouping the selected predicates with brackets into one or more predicate groups;
providing one or more operators between the predicate groups to define a composed filter; and
presenting the user the composed filter with the brackets and the operators.
